(19) United States
(12) Patent Application Publication
(10) Pub. No.: US 2006/0041486 A1
(43) Pub. Date: Feb. 23, 2006

(54) Method and system for providing analysis data on chemical compounds and for providing chemical compound availability information

(76) Inventor: Timothy M. Harris, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/189,315

(22) Filed: Jul. 26, 2005

Related U.S. Application Data
(63) Continuation of application No. 09/694,582, filed on Oct. 23, 2000, now abandoned.

(51) Int. Cl. G06Q 30/00

(52) U.S. Cl. 705/26

(57) ABSTRACT

A method and system for providing chemical compound product availability and contaminant and/or desired component information (certificate of analysis data) to end users of such products is disclosed. Chemical suppliers using computers (clients) access a central server computer, via the Internet or direct connection, to upload chemical compound lot analysis and quantity data to the server. The server stores the chemical compound lot data from suppliers in its database. Buyers or purchasers of such chemical compound products access the server using a computer and enter search criteria, specifying chemical names or identifiers, manufacturer name, chemical form (liquid, solid, granular, powder etc.), contaminants and maximum acceptable levels thereof. The server responds to the search request with a list of chemical compound lots previously stored in its database that satisfy the search criteria entered by the buyer. Buyers may reserve a portion or all of a particular chemical compound lot for purchase subject to negotiation of terms. Suppliers are notified electronically of the lot reservation event. A tracking history report for a particular chemical compound lot is also available from the server that provides useful data to track the use and repackaging history of a particular chemical compound lot.

### FIELD OF THE INVENTION

The present invention relates generally to electronic computer communication systems and more particularly to computer systems including remote access to a computer system that provides specialized data to users or purchasers and accepts data from product suppliers.

### BACKGROUND OF THE INVENTION

Electronic information exchange systems are rapidly proliferating in the present era due to technological advances and the sub-$1000 computer. Further, publicly accessible information exchange has literally exploded with the advent of the Internet and the World Wide Web (WWW) and computer programs known as “web-browsers” that enable easy access to data made available by countless “server” computers on the WWW. Most businesses maintain a “web” presence of some form, typically a “home page” wherein web “surfers” may find and obtain detailed information regarding the business' products or services.

Individual product details are difficult to compare with other similar products when one is able to view such information from only a single supplier at one time. The response by the computer communications industry has been to provide electronic catalog systems as described in U.S. Pat. No. 6,115,641 to Brown et al., that provides an “online” catalog of products from a variety of manufacturers. Brown et al. discloses a computer based product catalog system wherein manufacturer's product descriptions are electronically stored. Brown et al. also teaches that vendors can be given access to the electronic catalog to update or revise product details, inventory data and product pricing.

In the chemical compound industry, such a centralized cataloging system would be ideal for manufacturers to display their wares, and for purchasers to find the exact product desired. However, chemical compounds vary in quality from lot to lot and are not all the same, even from the same manufacturer. To guarantee both the integrity of a chemical compound product and determine whether it is acceptable for general use for an end users application, the quality of the compound lot is analyzed for certain desirable characteristics and undesirable components or contaminants. From the average of hundreds of test results a typical analysis and product specification is generated.

A chemical like sodium hydroxide, i.e. caustic soda, based upon the average of hundreds of tests may have a manufacturer's typical analysis and product specification of the following:

| | |
|---|---|
| Sodium Hydroxide (NaOH) | 49-51% |
| Sodium Carbonate (Na2CO3) | 0.20% (max,) |
| Sodium Chloride (NaCl) | 1.10% (max) |
| Iron (Fe) | 10 parts per million (ppm) |
| Mercury (Hg) | <1 part per billion (ppb) |
| Color | Clear to Opaque |

The same compound from another supplier may have a similar, yet unique, specification. Further complications with chemical compounds are encountered when such factors as shelf life, product form (liquid, granular, powder etc.), transportation and storage, and other characteristics are factored in when providing technical specifications therefor. In addition, most purchasers of chemical compounds demand certification of the purity of the product and desire to know the component makeup of the product, e.g., 50 percent NaOH and 50 percent H₂O.

Consequently, it is essential to most customers and end users of a chemical product that the manufacturer or supplier provide a document of record, at or prior to the customers receiving their order, that states the exact composition and constitution of their shipment or chemical compound lot. This document, known in the industry as a Certificate of Analysis (“COA”), certifies that the product received has been analyzed and tested for certain specified characteristics and components or contaminants. The COA certifies the analysis and test results to the purchaser. A COA is typically produced by a chemical compound certification analysis laboratory. Additional COA testing is often required to be performed when the product's integrity is potentially compromised, such as after transport or repackaging of the product or any other modification to the product.

Most companies, with few exceptions, demand that the delivered and/or ordered product conform to a particular specification. The lack of an acceptable and/or properly completed Certificate of Analysis accompanying, or in some instances, preceding the arrival of the chemical product, results in a multitude of problems, since this is the standard means of determining whether the product is fit for a specific use by the end user. The lack of a Certificate of Analysis, or an acceptable Certificate of Analysis, may result in any of the following:
1. Product rejection by the customer; the customer refusing to use the product to manufacture its goods.
2. Product recall of the customer's goods if it is determined after the fact that the product did not meet the specification once the COA is received or if the products integrity has been compromised since the original COA.
3. Demurrage costs, as the product remains in the truck or rail at the customer's site and the customer will not officially receive the product, awaiting the arrival of an acceptable COA.
4. Downtime/restart-up costs if the product is not approved for use due to awaiting the arrival of an acceptable COA.
5. Product spoilage due to delays and product shelf life issues.
6. Errant use of a nonconforming product due to issues regarding: shelf life;
manufacture by approved manufacturer at an unapproved plant, etc.
7. Other difficulties as a result of 1-6 above, including but not limited to: increased costs, disposal fees, environmental, health issues, etc.

What is needed is a central repository for chemical compound lot data wherein a supplier is given access to upload data on its available chemical compound lots and a purchaser may locate the supplier of the exact chemical compound lot desired, and obtain COA reports thereon without undue delay. A centralized chemical compound site on the WWW could help place rejected, refused or even waste product at one end (i.e. manufacturer) with a suitable user (customer) by making the exact compound specification available for immediate access by the entire chemical compound consuming industry. For example, ABC company may reject a compound with a shelf life of 30 days that another chemical compound user, with an acceptable shelf life of 120 days, will accept. Shelf life is readily ascertainable for many chemicals from the manufacturing date data provided in a COA. Such a matching feature could help significantly reduce product disposal costs and readily locate alternative acceptable customers. To further substantiate such a scenario, there are companies that pay millions of dollars to dispose of waste acids and those waste acids are regarded as beneficial in the production of fertilizers and other products and uses. With a centralized computer, accessible via the WWW or direct dial-up, capable of matching specifications at the supplier end with the specifications at the customer end, its user's profit margins would enjoy a well received increase.

### SUMMARY OF THE INVENTION

A method for exchanging information between providers and users of chemical compound products, according to one aspect of the present invention, comprises the steps of providing a chemical compound data information server system, the server system being computer based and having data processing and storage capabilities and electronic communication connections that permit users to electronically connect their computer with the server system to exchange chemical compound information therebetween, permitting limited read/write/delete computer access to the server system to approved suppliers having chemical compounds available for sale, and allowing the suppliers to upload to upload and remove from the server system chemical compound lot specification data and quantity data and corresponding chemical analysis data for each chemical compound lot, permitting read only computer access to the server system to approved users desiring data on available chemical compound lots, receiving chemical compound specification requirements from the users, and providing an electronic listing to the user's computer including the chemical compound lot specification data for chemical compound lots that satisfy the chemical compound requirements specification of the users.

One object of the present invention is to provide a system for users of chemical compounds to locate such products that meet their use specifications.

Another object of the present invention is to provide a system for sellers of chemical compounds to readily make their products known to end users.

Still another object of the present invention is to product a comprehensive history of the use a particular chemical compound lot for tracking a chemical compound lot into the marketplace.

A further object of the present invention is to enable chemical compound consumers or users to reserve a chemical compound lot, in whole or in part, for their own particular needs or usage.

These and other objects of the present invention will become more apparent from the following drawings and description of the preferred embodiment.

### BRIEF DESCRIPTION OF THE DRAWINGS

FIG. 1 is a block diagram of a system for providing analysis data on chemical compounds and for providing chemical compound availability information according to the present invention.

FIG. 2 is a flowchart of the main program executed by server 12.

FIGS. 3a and 3b are a flowchart for the process and respond to client requests routine.

FIG. 4 is a flowchart for the new user signup routine.

FIG. 5 is a flowchart for the chemical compound search routine.

FIG. 6 is a flowchart for the add/remove/update chemical compound data routine.

FIG. 7 is a flowchart for the provide certificate of analysis routine.

FIG. 8 is a flowchart for the provide chemical toxicity report routine.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

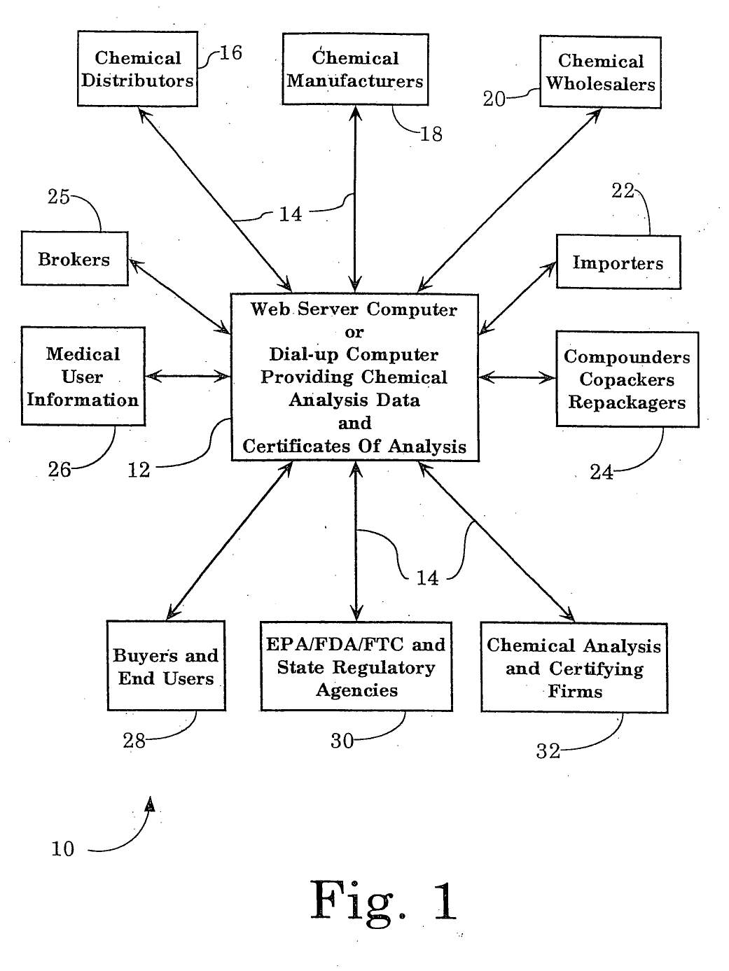

Referring now to FIG. 1, a diagrammatic illustration of a system 10 for providing chemical compound analysis and availability information, according to the present invention, is shown. The system 10 includes a server computer or server 12 having data processing, communications and storage capabilities typical of modem day web servers. Electronic communication links or data connections between server 12 and client computers are represented by links 14. Such communications links enable access by various users to electronically connect their computers, typically personal computers such as IBM® PC's, clones or Apple® Macintosh® computers, to server 12. Links 14 are either direct dial-up modem links to server 12 or are communication links through ISP's (Internet Service Providers) via standard TCP/IP communications protocols well known in the present day Internet wide area communications technologies.

Users presently contemplated to access server 12 include, but are not limited to, chemical distributors 16, chemical manufacturers 18, chemical wholesalers 20, chemical importers 22, compounders copackers and repackagers 24, medical users 26, buyers and end users of chemical compounds 28, EPA/FDA/FTC and state regulatory agencies 30, and chemical analysis and chemical certifying firms 32. Blocks 16-32 represent client computers linked to server 12 via communication links 14, with the descriptions in blocks 16-32 corresponding to users who may desire to access, upload chemical compound lot data to, and download chemical compound lot data from server 12. Information on chemical compound lots of all types is contemplated as available with the present system 10, including, but not limited to chemicals described in the Chemical Abstract Services (www.cas.org) web site and other chemical compounds such plastics, polymers, rubber, steel, metals, semiconductor materials and the so forth. The Chemical Abstract Service assigns a unique number to chemical compounds, e.g., salt (NaCl) is assigned the number 7647-114-5 and iron (Fe) is assigned the number 7439-89-6.

Operationally speaking, server 12 is placed in operation and readied for establishing communication links with computers 16-32 by using well known communications systems such as T1 lines connected to the Internet backbone, or direct dial-up modem telephone line links. If direct computer connections are implemented, links 14 require a bank of modems at the server end and a modem in each of the user's personal computers or client computers 16-32. Thus, client computers 16-32 access server 12 via direct dial-up or via the Internet. Upon gaining access to server 12, users are presented with the options to logon as a current user of the system, or a second option to establish a new account. Users must establish an account in order to gain limited access to the data stored on server 12. User accounts are established “online” via issuance of an account name and a corresponding password or via reply email to the user upon receiving verifiable billing information from the users. Online credit card verification or Purchase Order (PO) number and company verification are also contemplated as readily implemented for establishing new user accounts automatically when the user initially connects with server 12. Other methods for establishing user accounts well known in the Internet and telecommunications art are also contemplated as well.

Upon receiving valid account and password information, users will establish a communications link to the server 12 and interact with server 12 via a client computer (represented by items 16-32). One suitable approach is to use HTML (or the newer standard XTML) and related web browser and WWW technology to provide users access to server 12 and to provide a standard vehicle for exchange of information with server 12. More sophisticated technologies such as Javascript™, Java®, ActiveX® and other modern web browser extended features are contemplated as providing the functionality to readily implement data entry screens, data search screens, data modification screens, and data interchange, as well as displaying in a suitable format the results of any search requests. Server 12, in response to client requests, provides data to the client computers in HTML format in accordance with well known WWW standards. Each client computer executes a “web browser” program, such as Netscape Navigators or Microsoft Internet Explorer®, that enables convenient access to and interaction with server 12. Throughout the description of the present invention, it is contemplated that a GUI (graphical user interface) based operating system is executing on the client computers 16-32 and server 12, such as any of the Microsoft® Windows® operating system products (Windows 95®, Windows 98®, Windows NT®, Windows 2000®, Windows Millennium®, or alternative operating systems such as X-Windows running on Unix platforms, Linux platforms and the like, that present a GUI interface to the user and support a user input device such as a mouse, trackball or the like, as well as a keyboard input devices. Keyboard input sequences, as well as pointing device activation clicking, are contemplated for user input with respect to web browser and operating system user input functionality in the present invention. Well known data input components or user interaction components of a GUI based operating system, including pushbuttons or command buttons, text boxes for data entry, list boxes, drop-down listboxes, checkboxes, and other known “user input controls” used in most all GUI operating system are contemplated as being incorporated into the present invention for data input from the user on the client computer to facilitate data exchange between server 12 and the client computers 16-32.

Server 12 executes a database software package capable of storing, searching and retrieving variable length record set data, since the quantity of contaminant analysis data for each individual chemical will vary, so must the records or data available vary from chemical to chemical. Advanced database software and relational database design tools well known in the art provide such functionality and further discussion thereof is not required at this juncture.

Confidentiality, and protection of user data, is of imminent concern with users of system 10. Safeguards, such as access limitations, are implemented to prevent users from gaining access to competitor information considered confidential by the users of system 10.

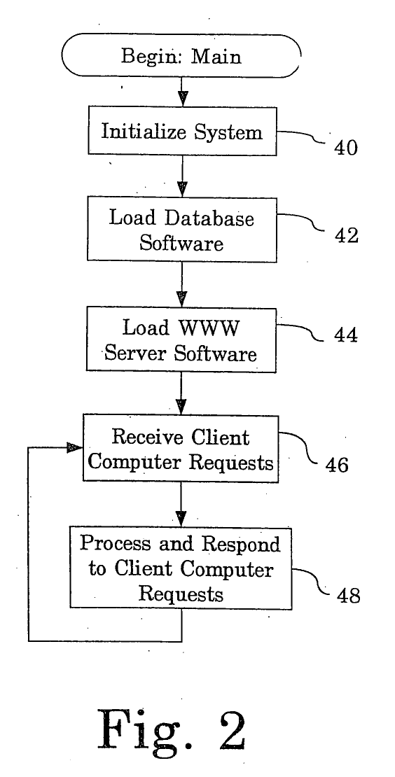

Upon initial access of server 12 via the WWW, users will be given several options. These options are described in detail below in conjunction with the flowcharts depicted in FIGS. 2-7. Throughout the description of the present invention, references to the phrase “chemical compound” include pure elemental chemicals (such as iron or Fe) as well as chemical compounds comprised of multiple elements from the periodic table.

Referring now to FIG. 2, a top level flowchart for the software executing on server 12 is shown. At step 40 the system executes an “initialize system” process typical of computer programs, such as loading necessary operating system executable programs and data structures associated therewith as well as initializing the hardware components of the system and establishing communications links with internet service providers. Then, at step 42, executable programs required for database access and management are loaded. Next, at step 44, any necessary web server programs (for example Apache Web Server) for providing WWW server access are loaded. After completing its initialization and program loading process, server 12 receives client computer requests at step 46 and processes those requests at step 48. Upon processing and responding to client computer requests in step 48, server 12 continues program execution at step 46 awaiting subsequent client computer (16-32 in FIG. 1) requests.

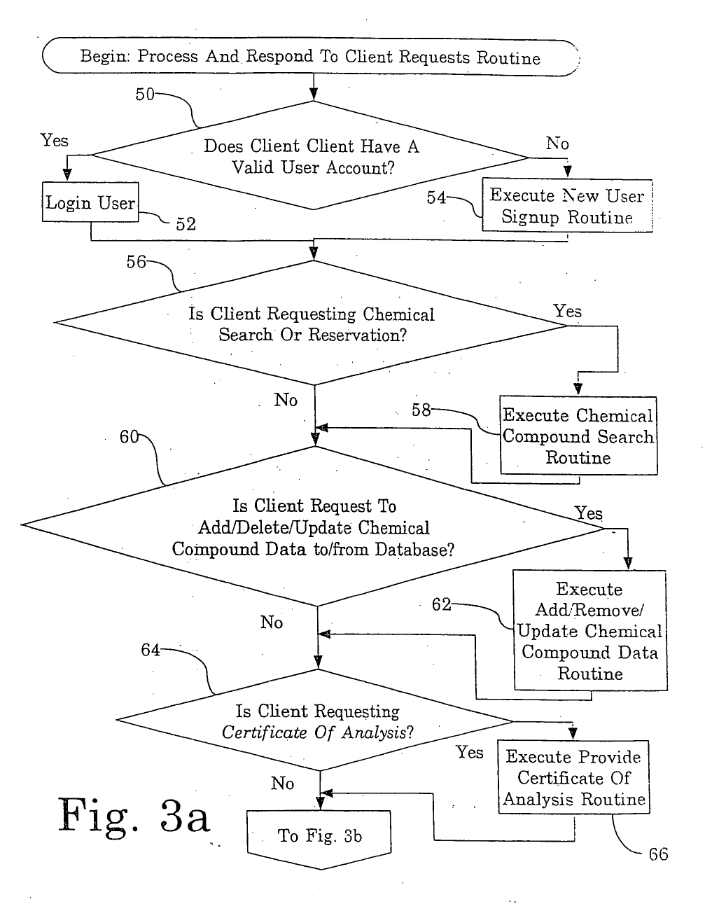

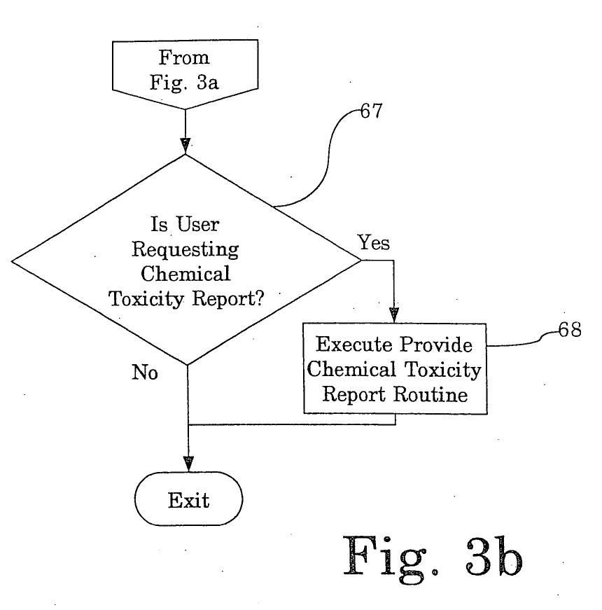

Referring now to FIGS. 3a and 3b, a flowchart for the process and respond to client requests routine, of step 48 of FIG. 2, is shown. At step 50, server 12 displays a request for the client to login, or alternatively, to sign-up as a new user. If the user has an existing valid logon account and corresponding password, program execution continues with step 52 and the user is “logged in” to the system. If the user does not have a valid logon account, program execution continues at step 54 wherein the new user sign-up routine is executed. Following steps 52 and 54, server 12 examines the request from the client computer to ascertain whether the client is requesting a chemical compound search at step 56. If a chemical compound search has been requested at step 56 program execution continues at step 58 wherein the chemical compound search routine is executed. Following step 58, step 60 is executed. If at step 56 the user or client request is not for a chemical compound search, execution continues at step 60 and the client request is examined to ascertain whether the client is requesting to add, delete, or update (modify) chemical compound lot data in the database stored on server 12. If at step 60 the client request is to add/delete/update chemical compound lot data, program execution continues at step 62 wherein the add/delete/update chemical compound data routine is executed. Following step 62, step 64 is executed. If at step 60 the client request is not for an add/delete/update of the chemical compound database, program execution continues at step 64 following step 60. At step 64 if the client has requested a Certificate Of Analysis. (COA) for a particular chemical compound lot, program execution continues at step 66 wherein the provide COA routine is executed. Step 67 follows steps 64 or 66. At step 67, if the client requests a chemical toxicity report then step 68 is next executed, else, execution returns to the calling program. Execution returns to the calling routine following step 68.

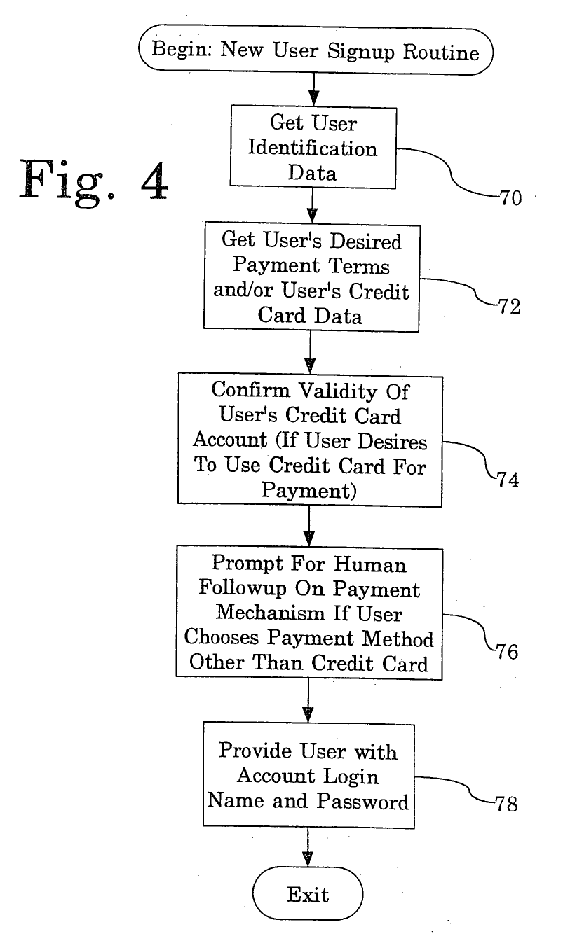

Referring now to FIG. 4, a flowchart for the new user sign-tip routine, step 54 of FIG. 3a, is shown. At step 70, server 12 displays on the client's screen a plurality of data fields (text boxes) for entry of user identification data, such as individual name, company name, address, telephone number, fax number, email address and other pertinent useful information such as chemical supplier, end user, and category such as distributor, repackager, handler, copacker, State or Federal agency, etc. The user enters data into the required fields and inputs a signal to the computer (clicks on a pushbutton) to forward the user data to server 12, such signals typically comprising mouse clicks, carriage returns or similar computer input signaling mechanism well known in the art. Next at step 72, server 12 displays options for the user to select the desired payment terms (check boxes or radio buttons to select PO number or credit card number or “other terms”) and optionally text boxes for receiving the user's credit card data. Upon completing the data entry fields at this step, the data is forwarded to server 12 by the user clicking a pushbutton. Either purchase order numbers (PO's), valid credit card accounts, or other predefined credit terms are required for a user to gain immediate access to the chemical compound database features provided by server 12. Next at step 74, server 12 contacts, via the WWW, a credit card validation web site in order to confirm the validity of the user's credit card account information. Step 74 is executed only if the user desires to use a credit card for payment. Next at step 76, if the user payment terms are unacceptable to the operators or owners of server 12, a prompt is issued to the system operator or support personnel to (on a display or printed on a printer) to initiate a manual confirmation of the new user's account and payment mechanism. Next at step 78, the user is provided with an account logon name and corresponding password either via instantaneous display on the user's client computer or via email confirmation. Following step 78, program execution returns to the calling routine.

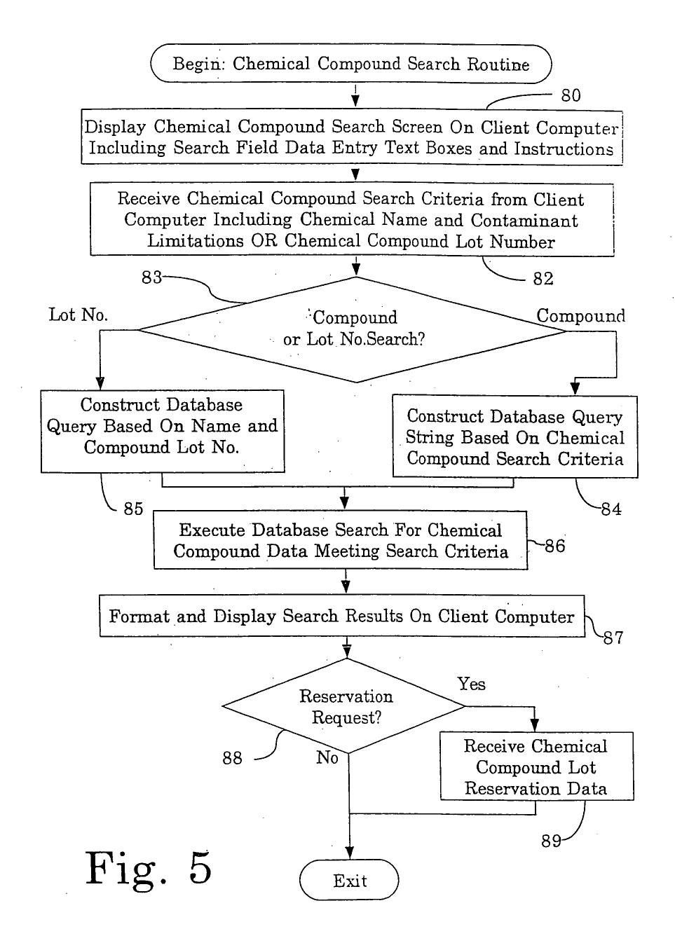

Referring now to FIG. 5, the chemical compound search routine, step 58 of FIG. 3a, is shown. At step 80 server 12 displays on the client screen a chemical compound search screen including a plurality of text box fields for receiving search data, including chemical name, chemical purity, purity range (e.g., 50 percent plus or minus 1 percent), manufacturer or supplier name, contaminants of interest and the tolerable levels of each contaminant (maximum levels as well as optional minimum level input boxes for contaminants are available to the user), and chemical compound name and lot number data entry text boxes if the user desires a chemical compound lot history report. Optionally, the server 12 is configured to process CAS (Chemical Abstract Services) registry numbers or DOT identification numbers. Other industry standard chemical identification schemes known in the art for identifying a specific chemical compound are also contemplated as implemented in the present invention. The client screen will include two search activation pushbuttons, one for requesting a compound contaminant search and the second pushbutton for initiating a chemical compound lot history tracking report. Additionally, the user is provided with instructions on what data to enter into the text box fields on his computer before initiating the search request. Next at step 82, server 12 receives the chemical compound search data from the client computer. The first type of search is an availability search for chemical compound lots that satisfy particular contaminant levels, and the second type of search is a chemical compound lot history tracking report. A history tracking report provides data to users on the various processors and/or purchasers of a particular chemical compound lot. A history tracking report is very useful when it is deemed necessary to track the status and usage of a chemical compound lot backwards in the chemical supply chain to ascertain when or where an undesirable contaminant was introduced into the chemical compound lot and to ascertain the end users of that particular lot of chemical compound. The search results will consist of one of two different types of search reports available from server 12, and at step 83 a test on the search request data or search criteria is performed. If the request is for a chemical compound lot tracking history report, program execution continues at step 85. At step 85, a search string is constructed to ascertain the users and/or purchasers of a particular chemical compound lot. The results of executing such a search string on the database will be a tracking history report that includes end user data and/or data on copackers, repackagers, handlers, transporters and the like who purchased and resold the chemical compound lot either with or without creating a new COA for the chemical compound lot. Program execution continues at step 86 after step 85.

If a chemical compound availability search is desired, then execution continues at step 84 following step 83. At step 84, server 12 constructs a database query search string in accordance with the chemical compound search data received from the client that includes chemical name, chemical form, desirable components (such as water or other component chemicals normally found in a particular chemical compound) and contaminant names and tolerable levels of such contaminants. Additionally, server 12 provides a hierarchy input scheme, such that the user may enter the order of interest for each contaminant that is specified in the search request. Alternatively, chemical compound degree of purity may be specified as a search result sorting parameter. Next, at step 86, the database search string, constructed in steps 83 or 84, is executed and results are obtained from the database management software in accordance with the search query string. Then at step 87, the search results data obtained in step 86 is formatted in standard HTML format and transmitted to the client computer causing the client to display the chemical compound lot data satisfying the search parameters or specifications. Preferably, the results are displayed on the client as a list of chemical compound lots and the specifications for each, including supplier of the compound, quantity available, location of the product, degree of purity and contaminant analysis or COA results. The list is ordered in accordance with the “superior” chemical compound lots at the top of the list, i.e., those product lots with lower levels of contaminants per the contaminant hierarchy previously entered by the user or those compounds having a degree of purity nearest the specified desired purity entered by the user. Alternatively, the compound lot search result list may include only supplier, location and quantity information, with the complete specification record being made available by a hyperlink to a secondary web page for each lot satisfying the search criteria. In the latter format, the user would mouse-click on (or enter keyboard commands such as TAB characters to select and spacebar to activate) a hyperlink entry in the list to display a new web page detailing the specifications or COA data for that particular chemical compound lot and server 12 would respond with the specific data retrieved from chemical compound lot database stored on server 12. If the search report requested is a chemical compound tracking history report, the formatting thereof may be configurable, using one of many well known programming mechanisms, to sort the data by end user name, date used/purchased, quantity, transportation data or storage data or in accordance with other, desires of the user requesting the report and in view of categories of data sorting available from the database on server 12.

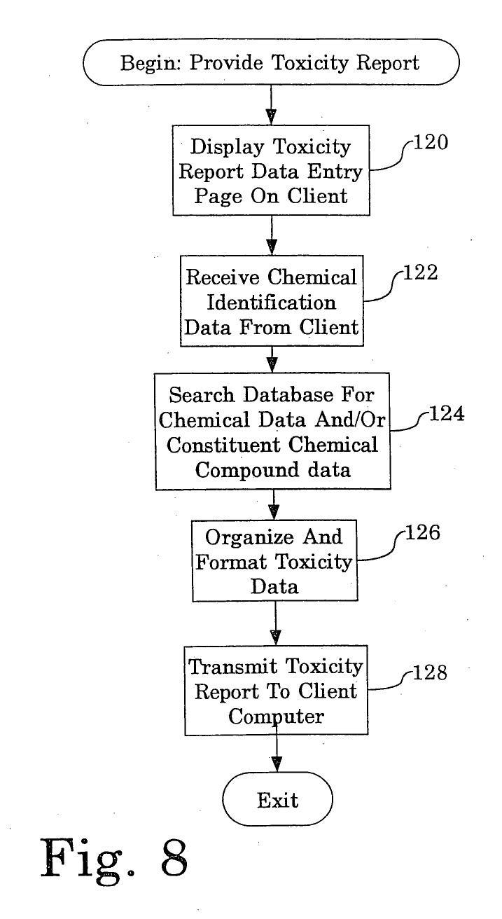

If the search results in step 87 are for available chemical compound lots meeting the users requirements, then server 12 also displays on the user's screen, in addition to the list of available chemical compound lots, a reserve pushbutton, a quantity text box, and checkboxes by each chemical compound lot description enabling the user to select (or check) a particular one of the chemical compound lots found in the search and enter a desired reservation quantity. Further, hyperlinks are optionally provided adjacent each listed chemical compound lot that generate a preformatted (including search criteria) request to server 12 for a chemical toxicity report for the corresponding chemical compound lot listed in step 87 (see toxicity report discussion for FIG. 8 below). A mouseclick of the reserve button, or other user input activation key used for navigation and control of web browser pages, sends a request to server 12 to reserve a quantity of the selected chemical compound lot located in the search. If, at step 88, a reserve request is received by server 12 then execution continues at step 89. At step 89, server 12 updates its chemical compound lot database to reflect the lesser available quantity for the chemical compound lot for which the user/purchaser has made a quantity reservation and to record the user name making the reservation in the database. Further, at step 89, the vendor or supplier of that chemical compound lot (the user that initially uploaded the data for the lot to server 12) that has been fully or partially reserved by a buyer or purchaser is notified either via email, or by an instant messaging technology, in regard to the existence of a reservation of some of its product. Alternatively, the vendor obtains of reservation information by accessing a special vendor web page provided by server 12 in regard to the availability status of the compound lots belonging to that vendor, be the vendor a chemical compound manufacturer, distributor, copacker, repackager, etc. For example, when a chemical supplier initially logs on to server 12, the account name for the supplier is used as a key triggering server 12 to perform a database search for chemical compound lots previously uploaded to server 12 by that supplier, and server 12 optionally provides a status report on the suppliers computer monitor regarding chemical compound lots available from that supplier and their current quantity reservation status. Such a status display includes a list of those chemical compound lots previously uploaded by the supplier, available quantities of each lot that are not reserved or allocated to customers as of that moment in time, and purchaser/buyer identification information in regard to each chemical compound lot and corresponding reservations received. Following steps 88 and 89, program execution returns to the calling routine.

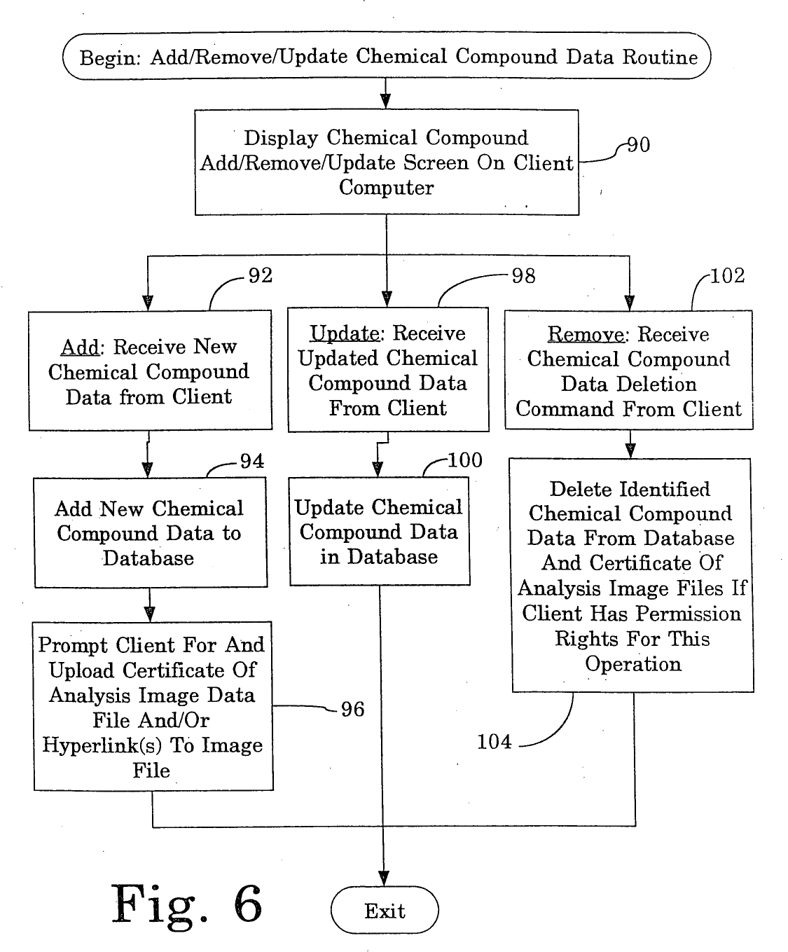

Referring now to FIG. 6, a flowchart for the add/remove/update chemical compound lot data routine is shown. The flowchart of FIG. 6 corresponds to step 62 of FIG. 3a. At step 90, server 12 displays on the client screen several options selectable by the user. In particular, the user is given the option via pushbuttons of adding, removing, or updating chemical compound lot data in the database stored on server 12. If at step 90 the user selects the “add” option to add data for a new chemical compound lot and corresponding COA analysis to the database, program execution continues at step 92 wherein the user enters the chemical compound name and form (granular, liquid, powder etc.) and server 12 displays a data entry screen for receiving COA data, and other relevant data, on the new chemical compound lot. Based upon the type of chemical for which the data is being received, server 12 presents the user with a predetermined array of text boxes for entry of contaminants or data of interest, storage and transportation background data, manufacturing date, approved vessel or containers used, quantity and other relevant data, including prior chemical compound lot numbers and chemical compound source information (the supplier name for the chemical compound lot) useful for tracking history purposes, thereby forcing standardizing of the format of data collected for each chemical compound lot. The predetermined array of text boxes specifies those chemical impurities for which analysis data is required, though a “not available” entry is acceptable to indicate that a particular contaminant test was not performed. However, if a “not available” entry is made for contaminant X testing analysis, and a search (FIG. 5) for that chemical compound is performed that includes a requirement that contaminant X be less than a specified level, then the lack of test data for contaminant X will result in that particular lot not satisfying a users search for such chemical compound lots with X contaminant below a specified level. Alternatively, server 12 can function to force industry standard testing for a group of contaminants by demanding test results for a predetermined list of contaminants for each particular chemical-compound. For example, if data is unavailable on a particular contaminant in citric acid, and data for cobalt testing is expected by server 12, server 12 is configurable to refuse to store the user's lot data if nickel test data is not provided by the user. Further, examination of the COA for the citric acid lot would reveal whether such a test was performed by the certifying analysis laboratory for that particular lot. Following step 92, the new chemical compound lot data is added to the database stored on server 12 at step 94. Next, at step 96, the user is prompted via the screen of the client computer to upload an image data file (GIF, JPEG or other commonly used image format compatible with web browsers) representing the scanned COA document image file or to provide a hyperlink that resolves to an Internet location for the file, either via WWW or FTP access, located on a server other than server 12. If an image data file is available from the user, it is uploaded by the user to server 12 and stored for later recall at step 96. Chemical analysis laboratories are contemplated as uploading such data in behalf of manufacturers or distributors of chemicals for whom they perform chemical analysis and generate COA data, in addition to the supplier or manufacturer uploading such data. Manufacturers will upload such data for their products since they oftentimes perform their own chemical analysis testing on new products sold in the chemical compound marketplace.

If at step 90, the user selects the “update chemical compound lot data”, program execution continues at step 98. At step 98 the user is prompted to enter a chemical compound name and/or lot number for which data modification is desired. Next, a screen is displayed on the client that includes the present known data for that particular chemical compound lot as stored in the database on server 12. The user is then given the option to modify any of the data fields via a plurality of data entry text boxes that contain the chemical compound lot information, including impurities or contaminants tested and quantity thereof (COA data), available quantity of the product, and any other information relevant to the handling, transportation data, shelf life, and storage container data for that particular chemical compound lot. Further, for the purposes of tracking chemical compound lot usage history, purchaser data for the lot is optionally added to the database for a particular chemical compound lot in step 98 to enable usage tracking of that particular chemical compound lot. Further data may also be added in the modify data process, including repackaging, handling and transporter data. Such information proves very useful in identifying where a chemical compound lot may have been contaminated if the lot is analyzed for contaminants by an end user who discovers the original COA data is no longer accurate. A tracking history report would then provide such repackager, handling and transporter data that will prove useful in identifying the source of the added contaminants. Next at step 100 the data received in the modification at step 98 is merged into the database stored on server 12. If at step 90 the user selects, via a client computer input, to remove a particular chemical compound lot from the database stored on server 12, program execution continues at step 102. At step 102, the user is prompted to enter identifying information for a particular chemical compound lot (i.e., lot number and chemical name) to request that the data be deleted from the database maintained on server 12. Server 12 then determines whether the user has permission rights to remove data from the database, either by verifying that this logged in user has previously entered the data for the particular chemical compound lot or has authority granted by server 12 via a special access account, and the chemical compound lot data is removed from the database. If the user does not have sufficient authority or permission rights to complete such a deletion transaction, server 12 notifies the user of the lack of permission rights in the users account to perform such an operation. Normally, deletion of lot records would only occur when a chemical compound lot previously intended to be made available is not subsequently made available. Where a chemical compound lot has been partially distributed in the marketplace, i.e. reservations and purchases have occurred, for the purposes of tracking usage history of a particular chemical compound lot, the data for that lot should not be removed from the database on server 12. Following steps 96, 100 or 104, program execution returns to the calling routine.

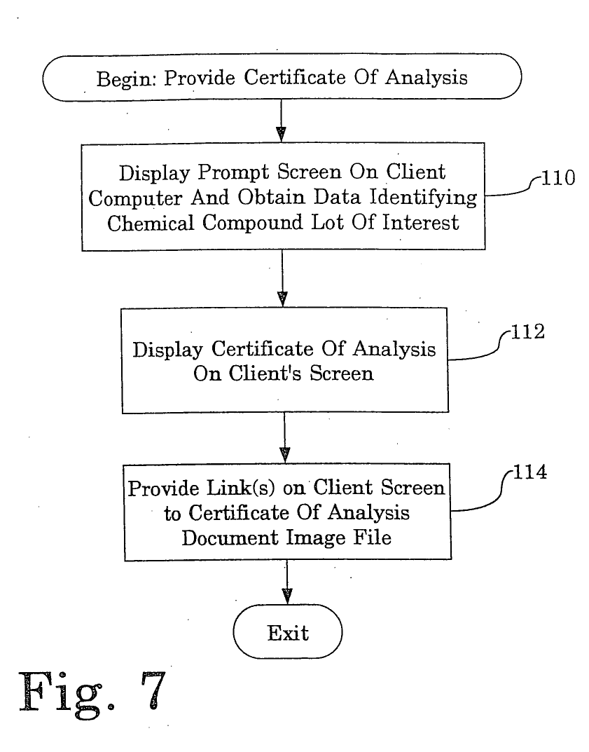

Referring now to FIG. 7, the provide Certificate of Analysis routine, corresponding to step 66 in FIG. 3a, is shown. At step 110, the client computer screen displays a prompt screen, composed by server 12, requesting user enter information identifying the chemical compound lot (by chemical name and lot number) of interest for which a COA is desired. Subsequently, at step 112, server 12 locates and displays a COA image file on the client computer screen either by downloading the COA image data file to the client computer and displaying that image file on the client screen, or by causing the file to be delivered to the client computer from another Internet server for which an address has been previously stored in the database. Alternatively, a hyperlink may be provided by server 12 on the users screen to the COA image data file, which is located on another WWW or FTP web server computer (not shown) at step 114, if the image file is not stored on sever 12. After step 114, program execution returns to the calling routine.

Toxicity and treatment information are also available from server 12 in response to a chemical toxicity report request. FIG. 8 is a flowchart of the provide chemical toxicity report routine. FIG. 8 is a more detailed description of the operation of server 12 corresponding to step 68 of FIG. 3b. At step 120, server 12 displays a chemical toxicity report request display on the client computer. The chemical toxicity report request page includes text boxes wherein the user enters chemical identification information such as chemical name (e.g., sodium hydroxide) or chemical symbol (such as NaOH), or Chemical Abstract Service number, or chemical lot number or other descriptive data concerning the chemical compound of interest. Any or all of the above chemical identification data is entered by the user, simplifying the users need for rapid identification of toxicity data on a particular chemical compound. Next, at step 122, server 12 receives the chemical identification or description data from the client and executes a search in the database, stored on server 12, for toxicity data relating to the chemical of interest. It is contemplated that more than one chemical compound may satisfy the chemical identification search criteria entered by the user, thus, server 12 compiles a report for all chemicals that satisfy, in whole or in part, the search criteria at step 124. At step 124 chemical toxicity data for the specific chemical(s) that satisfy the chemical identification data is compiled by server 12. Alternatively, where an end product having constituent chemical ingredients is of interest, the lot number of the end product provides a key or pointer for server 12 to obtain a list of chemical ingredients found in the end product from its database, provided the end product has a known COA previously uploaded to server 12. Toxicity data for all constituent chemical compounds that comprise an end product are compiled by server 12 from its database. Following step 124, the toxicity data is organized by priority of interest (most relevant data first) and formatted for display on the client computer. The toxicity data report optionally includes hyperlinks to related web sites that provide additional or more detailed data regarding the toxicity issues of a particular chemical compound, such a medical treatments and the like. Hazardous components are identified in the toxicity report by formatting such information as underlined, bold, alternative colors, or other well known techniques. Treatment recommendations (or hyperlinks treatment recommendations) are also included in the toxicity report. Next, at step 128, the chemical toxicity report is sent to and displayed on the client computer. After step 128, execution returns to the calling program.

End product information is also stored on server 12, including corresponding chemical components or ingredients and the lot number for those ingredients. With the cooperation of the chemical, pharmaceutical, cosmetic, and food industries (and other chemical industries), it is contemplated that a COA for their products is uploaded to server 12. The COA data, uploaded to server 12, for a particular end product will include a chemical ingredients list and corresponding chemical compound lot numbers for each ingredient. From the lot numbers for each ingredient chemical compound, a complete chemical toxicity report is compiled, including contaminant data, available from the database on server 12, for each of the chemical ingredients in an end product. A toxicity report based on that product lot number (e.g., the lot number for a soft drink having caffeine) and its constituent chemical ingredients (contained in the COA for the soft drink) are already known to server 12. From the list of constituent chemical ingredients, a toxicity report including chemical ingredients, lot numbers for the ingredients, and a summation of contaminants for that end product is compiled. End product quantity data is optionally received from the user in order to calculate with reasonable accuracy, total quantities of ingredients and contaminants. Treatment recommendations for each chemical ingredient and contaminant are also included in the report based on quantities of each present in the end product.

A variety of additional information and features are also available from server 12. Server 12 produces a “summation of contaminants” report that provides a convenient mechanism for users to readily ascertain whether a combination of particular chemical compound lots will result in excess presence of a particular contaminant. A user searches server 12 for chemical compound lots and selects a combination of particular compound lots and inputs to server 12 the mixing ratios, e.g. 2 parts chemical X, 3 parts chemical Y, 4 parts chemical Z, and server 12 multiplies the mixing ratio values times contaminant presence and sums the total expected contaminants in such a mixture. A summation of contaminants report is then generated and displayed on the client computer screen. The summation of contaminants report also includes “desired” chemical components normally found in many chemicals, such as water or other chemical compounds.

Hyperlinks to other WWW sites related to the chemical industry, such as containment or disposal sites, are provided in a web page accessible without a user account. Chemical descriptions are received from the client and corresponding disposal and containment firm names are displayed on the client.

Federal and State agencies have particular interest in the consumption of certain chemical compound whose uses are typically indicative of foul play. For example, it is well known that ether is commonly used in the manufacture of some illegal drugs. Providing Federal and State agencies with a mechanism for tracking the consumers of a plurality of “hit list” chemical compounds would serve the interests of law enforcement agencies. Server 12 provides such functionality through a special, restricted access, web page wherein the user enters a list of chemical compound names of interest and clicks a button to generate a report that includes usage, shipping and receipt information for a particular chemical compound. The sellers, purchasers, handlers and transporters of such chemical compounds are compiled in generated by server 12 and displayed on the client screen.

Material Safety Data Sheets (MSDS), well known in the chemical industry, are available from server 12 via an MSDS request web page. Users enter a chemical compound name and the name of the manufacturer, reseller, distributor, etc., and a search request command from the client causes server 12 to provide MSDS data to the client computer. Toxicity information is also provide in the MSDS data.

While the invention has been illustrated and described in detail in the drawings and foregoing description of the preferred embodiment, the same is to be considered as illustrative and not restrictive in character, it being understood that only the preferred embodiment has been shown and described and that all changes and modifications that come within the spirit of the invention are desired to be protected.

1-13. (canceled)

14. A method for exchanging information between providers and users of chemical compound products, said method comprising the steps of:
providing a chemical compound data information server system, said server system being computer based and having data processing and storage capabilities and electronic communication connections that permit users to electronically connect their computer with said server system to exchange chemical compound information there between;
permitting access to said server system to approved suppliers, and allowing said suppliers to upload to and remove from said server system chemical compound lot specification data and quantity data and corresponding chemical analysis data for each chemical compound lot;
receiving a plurality of certificates of analysis from said suppliers and associating each of the certificates of analysis with a particular chemical compound lot specification received from said suppliers, said plurality of certificates of analysis being stored on the server system over a historical period of time that extends beyond the availability of the product for purchase from said suppliers;
permitting access to said server system to approved users desiring data on chemical compound lots;
receiving chemical compound specification requirements from said users; providing an electronic listing to said user's computer including said chemical compound lot specification data for chemical compound lots that satisfy said chemical compound requirements specification of said users; and
electronically displaying at least one of the certificates of analysis upon receiving a request from the user's computer for the at least one certificate of analysis associated with a particular one of said chemical compound lots, and wherein the at least one certificate of analysis is in printable form.

15. The method of claim 14 including the following steps:
receiving critical contaminants data from said users identifying those contaminants of particular interest in said chemical compound requirements; and
wherein said providing an electronic listing step includes sorting said listing of chemical compound lots in accordance with said critical contaminants data.

16. The method of claim 14 wherein said chemical compound lot specification data includes component chemical compound specification data for all chemical compounds used to produce said chemical compound lot, and wherein said providing an electronic listing step identifies those chemical compound lots that were produced using chemical compounds that fail to meet said chemical compound requirements of said users.

17. The method of claim 14 including the following steps:
providing chemical compound toxicity data listings to said user's computer for said chemical compound lots that satisfy said chemical compound requirements specification.

18. The method of claim 14 including the following steps:
receiving approved supplier lists from said users; and
providing an electronic list of said chemical compound lots to said users that satisfy said chemical compound requirements specification of said users and that are available from suppliers found in said approved supplier list.

19. The method of claim 14 including the following steps:
receiving chemical compound lot sale data from said suppliers including the name of the purchaser thereof for a particular chemical compound lot;
receiving a chemical compound history tracking request from one of said users; and
generating a chemical compound lot tracking history for said particular chemical compound lot detailing the history of said chemical compound lot including the source thereof, and all of said suppliers and said users known to have purchased or processed said particular chemical compound lot.

20. The method of claim 14 including the following steps:
receiving chemical compound lot use and source data from said users;
receiving a chemical compound history tracking request from one of said users;
generating a chemical compound lot tracking history for said particular chemical compound lot detailing the history of said chemical compound lot including the source thereof, and all of said suppliers and said users known to have purchased or processed said particular chemical compound lot.

21. Computing device for exchanging information between suppliers of chemical compound products and users desiring information on chemical compound products, said device comprising:
a server computer having data processing and storage capabilities;
electronic communication means connected to said server computer that enables said server computer to electronically communicate with computers operated by the users and exchange data therebetween;
and wherein said server computer performs the following steps:
permitting access to said server computer to approved suppliers having chemical compound lots, and allowing said suppliers to upload to and remove from said server system chemical compound lot specification data and quantity data and corresponding chemical analysis data for each of said chemical compound lots;
receiving a plurality of certificates of analysis from said suppliers for each of said chemical compound lots and associating each of the certificates of analysis with a particular chemical compound lot specification received from said suppliers;
permitting access to said server computer to the users desiring data on chemical compound lots;
receiving chemical compound specification requirements from the users;
providing an electronic listing to the user's computer including said chemical compound lot specification data for chemical compound lots that satisfy said chemical compound requirements specification of the users; and
transmitting at least one of the certificates of analysis to the user's computer upon receiving a request from the user's computer for the at least one certificate of analysis associated with a particular one of said chemical compound lots.

22. The device of claim 21 wherein the server computer further performs the steps of:
storing the plurality of certificates of analysis over a historical period of time that extends beyond the availability of the product for purchase from said suppliers.
chemical compound lot specification data and quantity data and corresponding chemical analysis data for each of said chemical compound lots

23. The device of claim 21 wherein the server computer further performs the steps of:
receiving critical contaminants data from the users identifying those contaminants of particular interest in said chemical compound requirements; and
wherein said providing an electronic listing step includes sorting said listing of chemical compound lots in accordance with said critical contaminants data received from the users.

24. The device of claim 21 wherein said chemical compound lot specification data includes component chemical compound specification data for all chemical compounds used to produce said chemical compound lot, and wherein said providing an electronic listing step identifies those chemical compound lots that were produced using chemical compounds that fail to meet said chemical compound requirements of the users.

25. The device of claim 21 wherein the server computer further performs the steps of:
providing chemical compound toxicity data to the user's computer for said chemical compound lots that satisfy said chemical compound requirements specification.

26. The device of claim 21 wherein the server computer further performs the steps of:
providing material safety data sheet information for said chemical compound lots that satisfy said chemical compound requirements specification.

27. The device of claim 21 wherein the server computer further performs the steps of:
receiving approved supplier lists from each of the users; and
providing an electronic list of said chemical compound lots to the users that satisfy said chemical compound requirements specification of the users and that are available from suppliers found in said approved supplier list.

28. The device of claim 21 wherein the server computer further performs the steps of:
receiving chemical compound lot sale data from said suppliers including the name of the purchaser thereof for a particular chemical compound lot;
receiving a chemical compound history tracking request from one of the users; and
generating a chemical compound lot tracking history for said particular chemical compound lot detailing the history of said chemical compound lot including the source thereof, and all of said suppliers and the users known to have purchased or processed said particular chemical compound lot.

29. The device of claim 21 wherein the server computer further performs the steps of:
receiving chemical compound lot usage and source data from one of the users;
receiving a chemical compound history tracking request from one of the users;
generating a chemical compound lot tracking history data compilation for one of said chemical compound lots detailing the history of said chemical compound lot including the source thereof, and all of said suppliers and the users known to have purchased or processed said particular chemical compound lot; and
sending said electronic chemical compound lot tracking history data compilation to the user's computer that requested same.

30. A method comprising:
providing a chemical compound data information server system accessible over a network, said server system having a database containing a plurality of certificates of analysis and related chemical compound lot specification data from a plurality of suppliers;
from the database, retrieving a first certificate of analysis of a first supplier based on input received from a first user;
displaying the first certificate of analysis to the first user in a printable form;
from the database, retrieving a second certificate of analysis of a second supplier based on input received from a second user; and
displaying the second certificate of analysis to the second user in a printable form.

31. The method of claim 30, wherein the input received from the first and second user includes at least a portion of the chemical compound lot specification data related to the corresponding first and second certificate of analysis.

32. The method of claim 30, wherein the chemical compound lot specification data related to each of the plurality of certificates of analysis includes chemical ingredients and a corresponding chemical compound lot number.

33. The method of claim 30, wherein the network is the Internet.
